(19) United States
(12) Patent Application Publication
(10) Pub. No.: US 2005/0091174 A1
(43) Pub. Date: Apr. 28, 2005

(54) Searching for services in a UDDI registry

(75) Inventors: Rama K.T. Akkiraju, Yorktown Heights, NY (US); John Colgrave, Hampshire (GB)

Correspondence Address: IBM Corp, IP Law,, Route 134/Kitchawan Road, Yorktown Heights, NY, 10598, US

(73) Assignee: International Business Machines Corporation, Armonk, NY (US)

(21) Appl. No.: 10/690,686

(22) Filed: Oct. 22, 2003

(51) Int. Cl. G06F 17/60

(52) U.S. Cl. 705/75

(57) ABSTRACT

The present invention provides a method, apparatus, computer program product, and service which enables a UDDI registry to provide support for external matching services. Using tModels a service provider specifies its capabilities in a language, such as DAML-S, and a service requester specifies service requirements in the same or a similar language. As a result when a service requester contacts the registry to obtain details of service which matches the service requirements, the registry uses an external matching engine capable of comparing the capabilities and requirements in order to find suitable matching services.

### FIELD OF THE INVENTION

The present invention relates to searching for services in a UDDI registry and more particularly to matching service capabilities with service requester requirements.

### BACKGROUND TO THE INVENTION

Over recent years it has become commonplace for a business to provide the ability for a user to purchase goods from the business using a computer which communicates with a computer of the business. For example a business may provide a web site on the Internet which enables a user to purchase goods from the business over the world wide web. Following on from this success it has become a requirement to more easily locate suitable businesses to deal with. This requirement has been satisfied by the arrival of registry services, such as specified by UDDI (Universal Description, Discovery and Integration), which provide support for business entities which provide services.

UDDI is an industry effort to provide directory services for Web Services offered by businesses. It allows businesses to publish their services in a directory and enable other business representatives to locate partners and to form business relationships based on the web services they provide. The UDDI specification provides structural templates for representing information about business entities, the nature of their services, and mechanisms to access them. These are facilitated by standards such as Web Services Definition Language (WSDL), and Simple Object Access Protocol (SOAP). It also provides a standardized set of categories such as North American Industry Classification System (NAICS) and United Nations Standard Product and Services Classification (UNSPSC) for organizing the services offered by businesses in the directory to enable quick business-level and service-level discovery.

However, in its current specification level, UDDI provides a somewhat simplistic approach to capturing business and service semantics search mechanism. Several approaches have been suggested to work around this problem.

The Semantic Web is an effort to extend the current World Wide Web by representing data on the web in a meaningful and machine-interpretable form to better enable computers and people to work in cooperation [McIIraith et al., 2001]. It is a vision for a Web of applications (public or private) whose ‘properties, capabilities, interfaces, and effects are encoded in an unambiguous, and machine-interpretable form’ [Berners-Lee et al., 2001]. Recently, basing their work on two of the important existing technologies for developing the Semantic Web, namely extensible Markup Language (XML) [XML 2000] and the Resource Description Framework (RDF) [RDF 1999], this community has developed ontology markup languages such as DAML [DAML 2000], DAML+OIL [DAML+OIL 2001] and OWL [OWL 2002]. These ontology languages capture the relationships between various entities in a domain and allow for automatic inferencing of relationships. To address the lack of semantics in the industry backed Web Services standards, the Semantic Web Community developed a DAML+OIL ontology for Web Services known as DAML-S [Ankolekar et al., 2002]. This DAML family of semantic markup languages together lays the foundation for Semantic Web Services [McIlraith, Son and Zeng 2001], automatic service discovery, and service composition.

Paolucci et.al., tie the semantic-representation of web services work with web service directories/registries by arguing that web service discovery should be based on the semantic match between a declarative description of the service being sought, and a description of the service being offered [Paolucci et al., 2002-1; Payne et al., 2001]. In their work, they present a sample semantic matching algorithm that matches the inputs, outputs, preconditions and effects of service requests with those of service advertisements. They also present a mapping between service capability definitions in DAML-S [Ankolekar et al., 2002] and UDDI records providing, therefore, a way to record semantic information within UDDI records. Furthermore, they show how this encoded information can be used within the UDDI registry to perform semantic matching.

In Paolucci et al's approach, the functionality of UDDI registry is untouched but the behavior of semantic matching is simulated by intercepting the search calls to UDDI registry and performing semantic matching outside of the UDDI registry. While this approach is a good start, has an inherent disadvantage. Every user of UDDI registry has to have the infrastructure developed by Paolucci et al, for the semantic matching to take place. This is not only cumbersome but also limits the general availability of this function. To address his limitation in a follow up work, Akkiraju et al., [Akkiraju et al., 2003] present a design mechanism for a tighter integration of semantic matching with UDDI registry by directly extending UDDI's inquiry Application Programming Interface (API) (find_service( )) and its implementation. This approach incorporates semantic matching directly in UDDI registry by altering the find_service( ) API that users of UDDI registry are familiar with. While this is a workable solution, it proposes changes to the standard UDDI API specifications, thereby making this implementation out of synchronisation with standards.

### SUMMARY OF THE INVENTION

The present invention provides a new method, apparatus, computer program product and service for providing an external matching feature in a UDDI which can support external matching services within UDDI including semantic matching without requiring a change to the standard UDDI specifications.

According to a first aspect the present invention provides a data processing method for a UDDI registry to enable location of details of services which match service requester requirements, the method of the UDDI registry comprising: receiving a standard UDDI request to locate service details, the request comprising details of a tModel which defines service requirements specified in a particular language; locating details of at least one service, the details comprising a tModel which defines service capabilities specified in the particular language; selecting from a plurality of external matching services an external matching service which is capable of comparing the service requirements and service capabilities, wherein each of the external matching service is accessed through an interface-defined in a tModel; using the external matching service to filter the located details to find those with indicated service capabilities which match the service requirements.

According to a second aspect the present invention provides a method for a service provider to provide details of capabilities of a service which it provides to a UDDI registry, the method comprising the steps: making a description of the service capabilities accessible to the UDDI registry, the description comprising details of the service capabilities specified in a particular language, the particular language being recognisable to an external matching engine available to the UDDI registry; and sending details of the service to the UDDI registry, the details including a tModel which includes a reference to the description and a specification of the particular language.

According to a third aspect the present invention provides a method for a service requester to request details of services from a UDDI registry according to service requirements, the method comprising the steps: making a description of the service requirements accessible to the UDDI registry, the description comprising details of the service requirements specified in a particular language., the particular language being recognisable to an external matching engine available to the UDDI registry; sending a tModel to the UDDI registry, the tModel including a reference to the description and a specification of the particular language; and sending a request to the UDDI registry to obtain details of services according to the service requirements, the request including a reference to the tModel previously sent to the UDDI registry.

According to a fourth aspect the present invention provides a UDDI registry for locating details of services which match service requester requirements, the UDDI registry comprising: means for receiving a standard UDDI request to locate service details, the request comprising details of a tModel which defines service requirements specified in a particular language; means for locating details of at least one service, the details comprising a tModel which defines service capabilities specified in the particular language; means for selecting from a plurality of external matching services an external matching service which is capable of comparing the service requirements and service capabilities, wherein each external matching service is accessed through an interface defined in an interface tModel; and means for using the external matching service to filter the located details to find those with indicated service capabilities which match the service requirements.

According to a fifth aspect the present invention provides a service provider for providing details of capabilities of a service which it provides to a UDDI registry, the service provider comprising: means for making a description of the service capabilities accessible to the UDDI registry, the description comprising details of the service capabilities specified in a particular language, the particular language being recognisable to an external matching engine available to the UDDI registry; and means for sending details of the service to the UDDI registry, the details including a tModel which includes a reference to the description and a specification of the particular language.

According to a sixth aspect the present invention provides a service requester for requesting details of services from a UDDI registry according to service requirements, the service requester comprising: means for making a description of the service requirements accessible to the UDDI registry, the description comprising details of the service requirements specified in a particular language, the particular language being recognisable to an external matching engine available to the UDDI registry; means for sending a tModel to the UDDI registry the tModel including a reference to the description and a specification of the particular language; and means for sending a request to the UDDI registry to obtain details of services according to the service requirements, the request including a reference to the tModel previously sent to the UDDI registry.

According to a seventh aspect the present invention provides a computer program product comprising instructions which, when executed on a data processing host, cause the data processing host to carry out a method for a UDDI registry to enable location of details of services which match service requester requirements, the method comprising the steps: receiving a standard UDDI request to locate service details, the request comprising details of a tModel which defines service requirements specified in a particular language; locating details of at least one service, the details comprising a tModel which defines service capabilities specified in the particular language; selecting from a plurality of external matching services an external matching service which is capable of comparing the service requirements and service capabilities, wherein each external matching service is accessed through an interface defined in an interface tModel; and using the external matching service to filter the located details to find those with indicated service capabilities which match the service requirements.

According to an eighth aspect the present invention provides a computer program product comprising instructions which, when executed on a data processing host, cause the data processing host to carry out a method for a service provider to provide details of capabilities of a service which it provides to a UDDI registry, the method comprising the steps: making a description of the service capabilities accessible to the UDDI registry, the description comprising details of the service capabilities specified in a particular language, the particular language being recognisable to an external matching engine available to the UDDI registry; and sending details of the service to the UDDI-registry, the details including a tModel which includes a reference to the description and a specification of the particular language.

According to a ninth aspect the present invention provides a computer program product comprising instructions which, when executed on a data processing host, cause the data processing host to carry out a method for a service requester to request details of services from a UDDI registry according to service requirements, the method comprising the steps: making a description of the service requirements accessible to the UDDI registry, the description comprising details of the service requirements specified in a particular language, the particular language being recognisable to an external matching engine available to the UDDI registry; sending a tModel to the UDDI registry, the tModel including a reference to the description and a specification of the particular language; and sending a request to the UDDI registry to obtain details of services according to the service requirements, the request including a reference to the tModel previously sent to the UDDI registry.

According to a tenth aspect the present invention provides a UDDI registry service for locating details of services which match service requester requirements, providing the UDDI registry service comprising the steps: receiving a standard UDDI request to locate service details, the request comprising details of a tModel which defines service requirements specified in a particular language; locating details of at least one service, the details comprising a tModel which defines service capabilities specified in the particular language; selecting from a plurality of external matching services an external matching service which is capable of comparing the service requirements and service capabilities, wherein each external matching service is accessed through an interface defined in an interface tModel; and using the external matching service to filter the located details to find those with indicated service capabilities which match the service requirements.

According to an eleventh aspect the present invention provides a provider service which provides details of capabilities of a service which it provides to a UDDI registry, providing the service comprising the steps: making a description of the service capabilities accessible to the UDDI registry, the description comprising details of the service capabilities specified in a particular language, the particular language being recognisable to an external matching engine available to the UDDI registry; and sending details of the service to the UDDI registry, the details including a tModel which includes a reference to the description and a specification of the particular language.

According to a twelfth aspect the present invention provides a requester service for requesting details of services from a UDDI registry according to service requirements, providing the service comprising the steps: making a description of the service requirements accessible to the UDDI registry, the description comprising details of the service requirements specified in a particular language, the particular language being recognisable to an external matching engine available to the UDDI registry; sending a tModel to the UDDI registry, the tModel including a reference to the description and a specification of the particular language; and sending a request to the UDDI registry to obtain details of services according to the service requirements, the request including a reference to the tModel previously sent to the UDDI registry.

A UDDI registry service for locating details of services which match service requester requirements, providing the UDDI registry service comprising the steps: receiving a standard UDDI request to locate service details, the request comprising details of a tModel which defines service requirements specified in a particular language; locating details of at least one service, the details comprising a tModel which defines service capabilities specified in the particular language; selecting from a plurality of external matching services an external matching service which is capable of comparing the service requirements and service capabilities, wherein each external matching service is accessed through an interface defined in an interface tModel; and using the external matching service to filter the located details to find those with indicated service capabilities which match the service requirements.

Preferably details of at least one service are first found by matching requirements and capabilities specified in standard UDDI categories, for example North American Industry Classification System (NAICS) and United Nations Standard Product and Services Classification (UNSPSC). Those found are then the only ones considered when locating those with service capabilities defined in the same particular language as the service requirements.

Optionally, new external matching engines which implement the interface defined in the external matching interface tModel can be registered with the UDDI registry. When such an external matching engine is registered it is included in the plurality of matching engines from which a suitable matching engine is selected for comparing service capabilities with requirements.

Preferably the standard UDDI request is a find_tModel request, alternatively it could be a find_service request.

Preferably the particular language is one of XML, UML, DAML, DAML-S and WSDL.

Accordingly the present invention differs from Paolucci et al and Akkiraju et al's in the several ways. For example, semantic matching is incorporated into UDDI without altering for example, the standard UDDI V2.0 specification, by making use of a standard UDDI interface and using tModels to define service requirements and capabilities. Further, external matching services, described as such because they are not part of the UDDI standard and therefore external to the UDDI registry, are accommodated through an interface defined in an interface tModel, which for example, is defined by the registry. This enables easy incorporation of 3rd party external matching engines into the searching facilities provided by the UDDI registry. For example, such external matching engines might be more effective and efficient in performing matching than previous engines. Such flexibility is essential for widespread adoption of the invention. Further for example, users can request not only matching of semantic descriptions of services written in DAML-S but also matching of descriptions written in UML or WSDL etc.

### BRIEF DESCRIPTION OF THE DRAWINGS

The invention will now be described, by way of example only, with reference to a preferred embodiment thereof, as illustrated in the accompanying drawings, in which:

FIG. 1 is a schematic diagram of a data processing system in which the preferred embodiment of the present invention can be advantageously applied;

FIG. 2 is a schematic diagram of a UDDI registry;

FIG. 3 is a tModel for defining a “describedUsing” categorization;

FIG. 4 is an example of a tModel for defining an external language for use in a UDDI registry;

FIG. 5 is an example of a template tModel for a service provider to define the capabilities of its services in an external language;

FIG. 6 is an example of a template tModel for a service requester to define a service requirements in an external language;

FIG. 7 is a tModel for defining a “ClientRequirements” categorization;

FIG. 8 is an example of a tModel for representing an interface to an external matching service; and

FIG. 9 is a flow diagram of a method for the UDDI registry to process an inbound request from a service requester to locate details of services based on specified requirements.

### DESCRIPTION OF THE PREFERRED EMBODIMENT

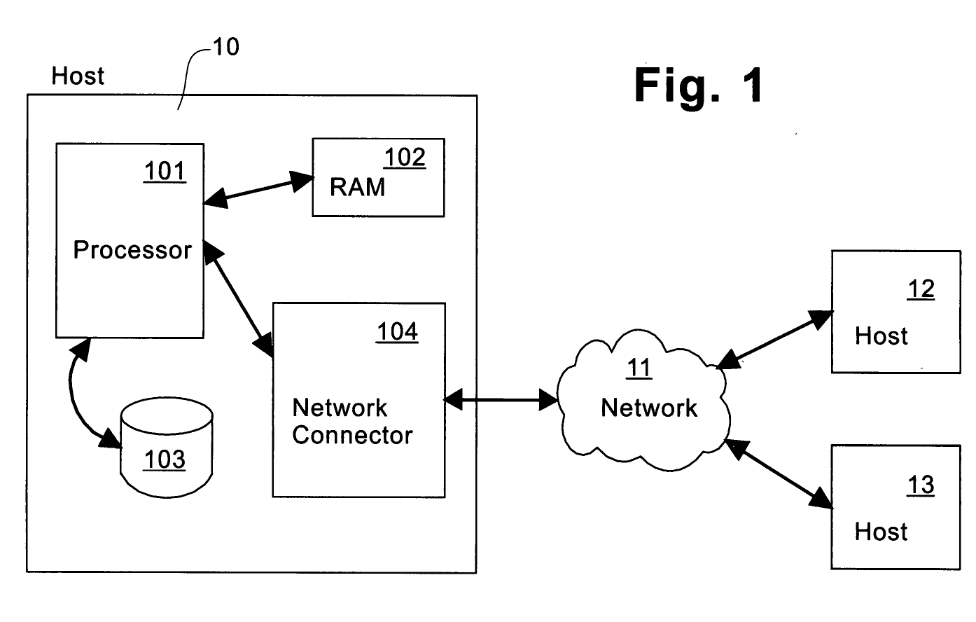

In FIG. 1, a client/server data processing host 10 is connected to other client/server data processing host 12 and 13 via a network 11, which could be, for example, the Internet. In the preferred embodiment a UDDI registry may be installed on any such client/server and accept requests to define/update details of a web service, or obtain details of a web service, from a user using the same or another client/server data processing host. The UDDI registry may further accept requests for registration of external matching engines. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13.

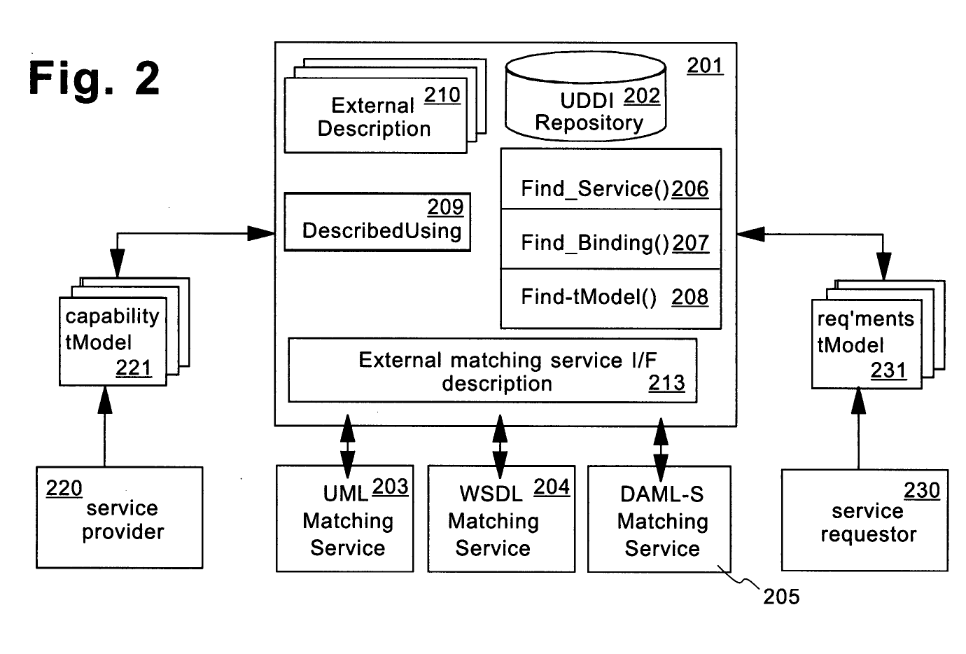

FIG. 2 is a schematic diagram of a UDDI registry 201 providing external matching services, a service provider 220, and a service requester 230 according to the preferred embodiment of the present invention.

The UDDI registry has access to external matching services such as UML 203, WSDL 204 and DAML_S 205, each of which implement an interface which is defined in a tModel 213 provided by the registry. As a result the registry can use the external matching services, through the interface, to match service capabilities with specified requirements of service requesters. The UDDI registry further provides a “describedUsing” categorization tModel (209) and “externalDescription” tModels (210) for each of the external matching services available. These tModels are used by service providers and service requesters to specify the external matching language of their specified capabilities and requirements.

The UDDI registry 201 receives service descriptions in the form of tModels 221 from service providers, such as service provider 220, stores them in a UDDI repository 202, and makes them available to service requesters, such as service requester 230. The service descriptions include details of service capabilities specified in one or more external languages, such as DAML-S, UML or WSDL, and optionally also in standard UDDI categories. The UDDI registry further receives service requirements, in the form of tModels 231, from service requesters such as service requester 230 and stores then in the UDDI repository 202 for later use by the requester. Each service requirement includes details of required service capabilities in one or more external languages, such as DAML-S, UML or WSDL, and further optionally in standard categories defined by UDDI.

In order to facilitate service requesters obtaining details of services the UDDI registry makes an API available which includes the functions Find_Service( ) 206, Find_Binding( ) 207, and Find_tModel( ) 208. When the service requester 230 wishes to obtain details of services which match its requirements it sends a find_tModel( ) request to the UDDI registry specifying a requirements tModel 231, as previously provided to the UDDI registry, which describes the requirement. On receipt of this request the UDDI registry obtains the specified requirements tModel from the UDDI repository and then finds any tModels which describe services that meet the requester requirements specified in the requirements tModel. For example, if the requirements tModel provides requirements both in standard UDDI categories and in an external language, the UDDI registry will first locate a set of service details which meet the standard UDDI categories, and then, based on the external language requirements, choose an external matching engine to search the set of details located to find those which also meet the requirements specified in an external language. If one or more suitable services are found the corresponding tModels of those services are returned to the service requester which then uses find_service( ) and find_binding( ) to obtain access to the particular services which it chooses to access from those returned.

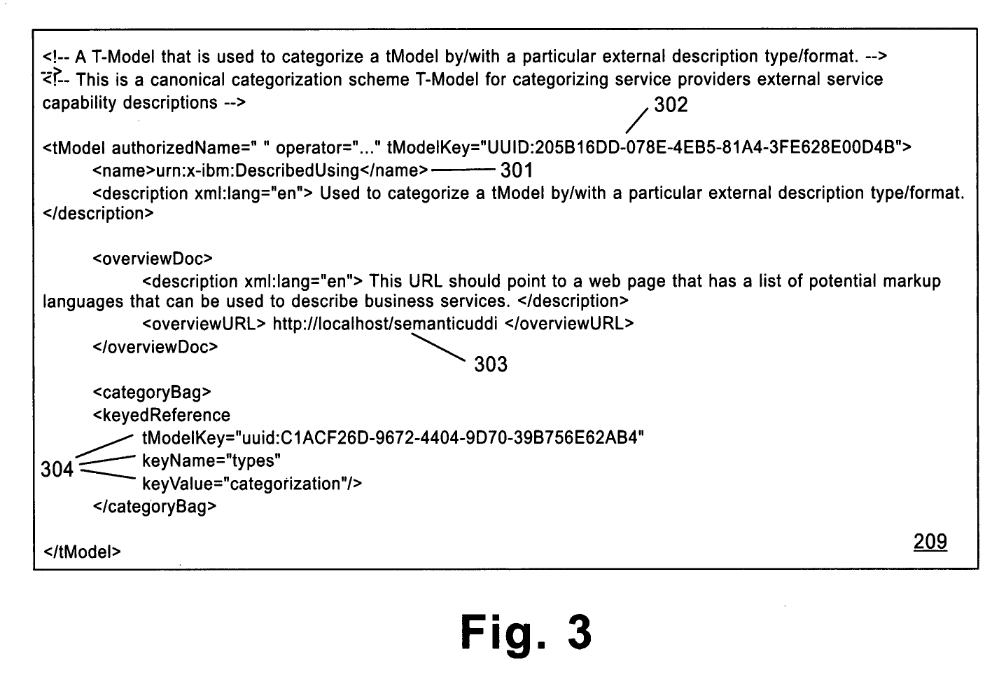

In order to facilitate the preferred embodiment of the present invention it is necessary to define several tModels which are not standard in UDDI and these are described with reference to FIGS. 3 to 8.

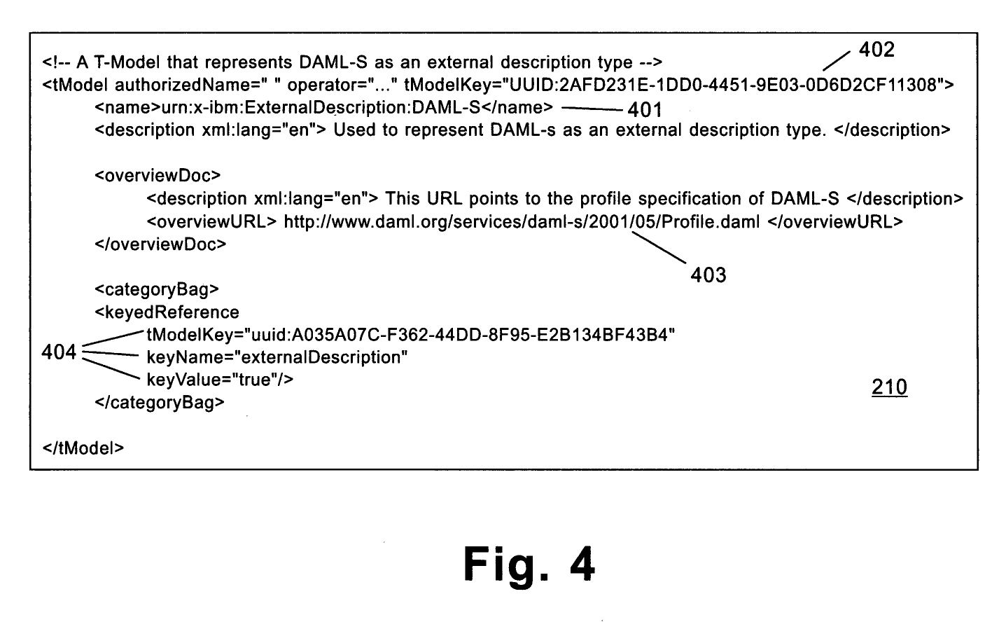

The first two tModels, shown in FIGS. 3 and 4, are defined to enable service providers to specify a language in which their capabilities are defined and to enable service requesters to specify a language in which their requirements-are specified. Theses are the “describedUsing” and “externalDescription” categorization tModels.

FIG. 3 shows a “describedUsing” categorization tModel (209 of FIG. 2) which defines a category which can be used in a tModel to specify that an external language is being used. The tModel includes a name of the categorization which is defined as “describedUsing” 301, a UUID (Universal Unique Identifier) 302, and a URL 303 which defines the location of a list of potential markup languages. The figure further shows a UUID, keyName and keyValue settings 304 which define the tModel as a categorization tModel.

FIG. 4 shows an example of an externalDescription tModel (210 of FIG. 2) which represents the DAML-S language. The tModel includes a name 401 which specifies a name for the language (DAML-S) which it represents, a UUID 402 which uniquely identifies the tModel, the URL 403 of a profile specification of the DAML-S language, and a UUID, keyName and keyValue settings (404) which indicate that the tModel defines an “externalDescription”. One such externalDescription tModel is created for each external language supported by the UDDI registry, and are used in conjunction with the “describedUsing” category as will be discussed below. A tModel for a different language would specify at different appropriate name at 401, a different UDDI at 402 and a different appropriate URL at 403.

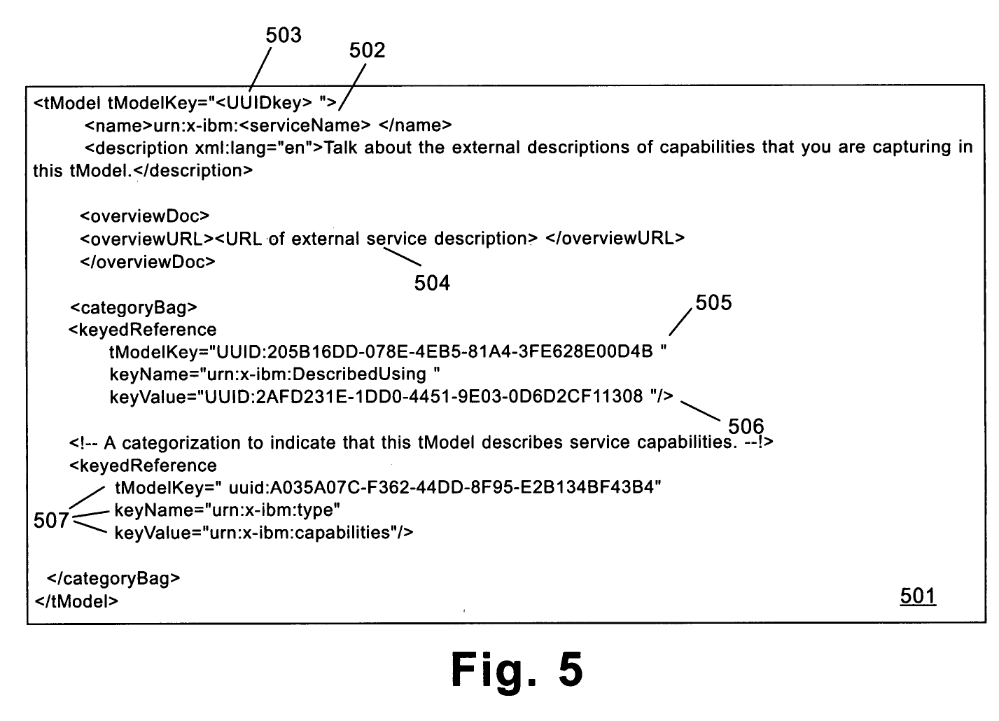

Having defined these tModels a template for a tModel is defined for a service provider to define the capabilities of a service in one or more external languages. Such a tModel template for specifying capabilities described in DAML-S is shown in FIG. 5 and is used to create service capability tModels such as 221 of FIG. 2. The name of the service is defined at 502, a UUID for the service is defined at 503, and the URL of a description of the service capabilities in an external language is defined at 504. The template further includes two keyedReferences. The first keyed reference specifies the language of the capabilities as DAML-S by using the describedUsing categorization, and as a result the tModelKey 505 specifies the UUID of the “describedUsing” tModel (302 of FIG. 3) and the keyValue 506 is the UUID of the DAML-S tModel (402 of FIG. 4). The second keyedReference 507 specifies that the tModel contains service capabilities. Note that the tModel may also contain capabilities specified in standard UDDI categories. Further note that a service may-wish to describe its capabilities in several different external languages and accordingly it can define a tModel for each of these languages. Further note that if the service capabilities were defined in a different language the UUID defined at 506 would be the UUID of an external description tModel which represents that language.

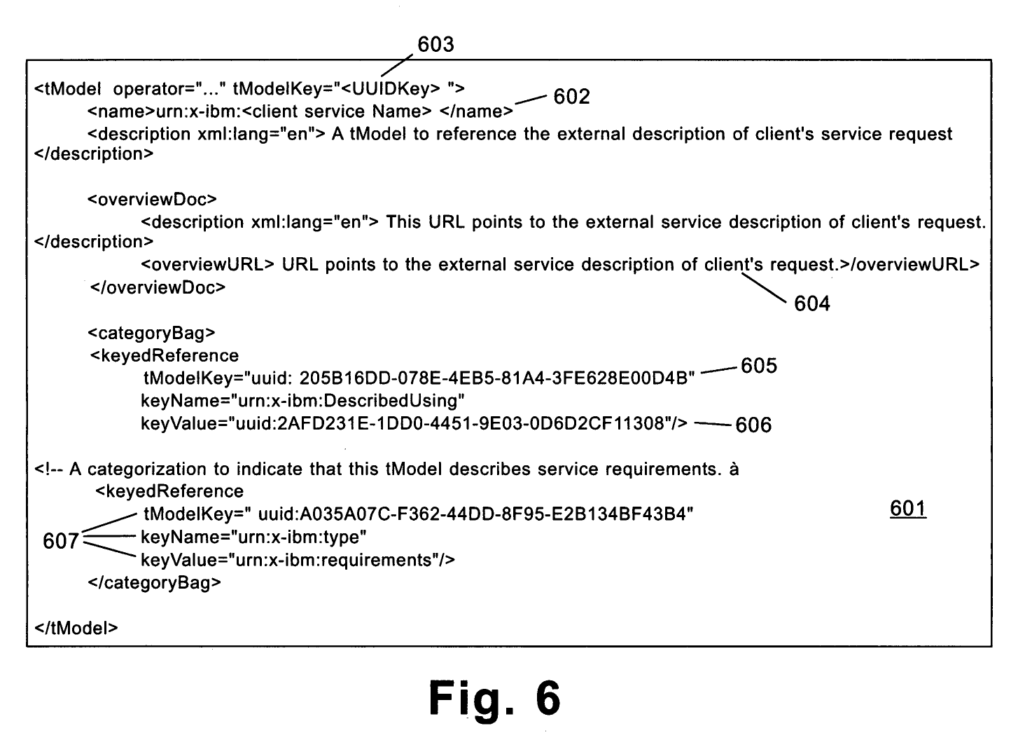

FIG. 6 shows a template of a tModel, such as tModels 222 of FIG. 2, which is defined for a service requester to define requirements for a service that is defined in the DAML-S language. The name of the client service requirements is defined at 602, a UUID for the requirements is defined at 603, and the URL of a description of the service requirements in an external language is defined at 604. The template further includes two keyedReferences. The first keyed reference specifies the language of the requirements as DAML-S by using the describedUsing categorization, and as a result the tModelKey 605 specifies the UUID of the describedUsing tModel (302 of FIG. 3) and the keyValue 606 is the UUID of the DAML-S tModel (402 of FIG. 4). The second keyedReference specifies that the tModel contains client requirements. Further the tModel may contain capabilities specified in standard UDDI categories. Further note that if the service requirement were defined in a different language the UUID defined at 606 would be the UUID of an external description tModel which represents that language.

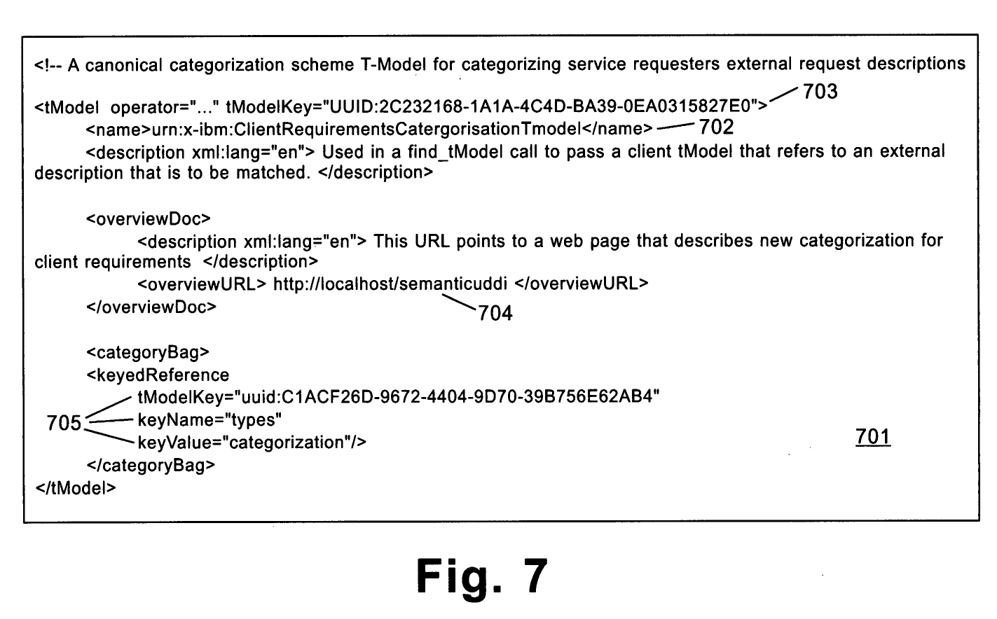

FIG. 7 shows a client requirements categorization tModel. A client requirements categorization tModel is defined once and can be used with any particular external description, for example DAML-S. The tModel 701 includes a name of the categorization which is defined as ClientRequirementsCategorisation tModel 702, a UUID (Unique Universal Identifier) 703, and a URL 704 which defines the location of a list of potential markup languages. The figure further shows a UUID, keyName and keyValue settings 705 which define the tModel as a categorization tModel. The client requirements categorization tModel is used in a find_tModel request to specify that a tModel, which is provided with the request, defines the external description of a required service in a tModel according to FIG. 6.

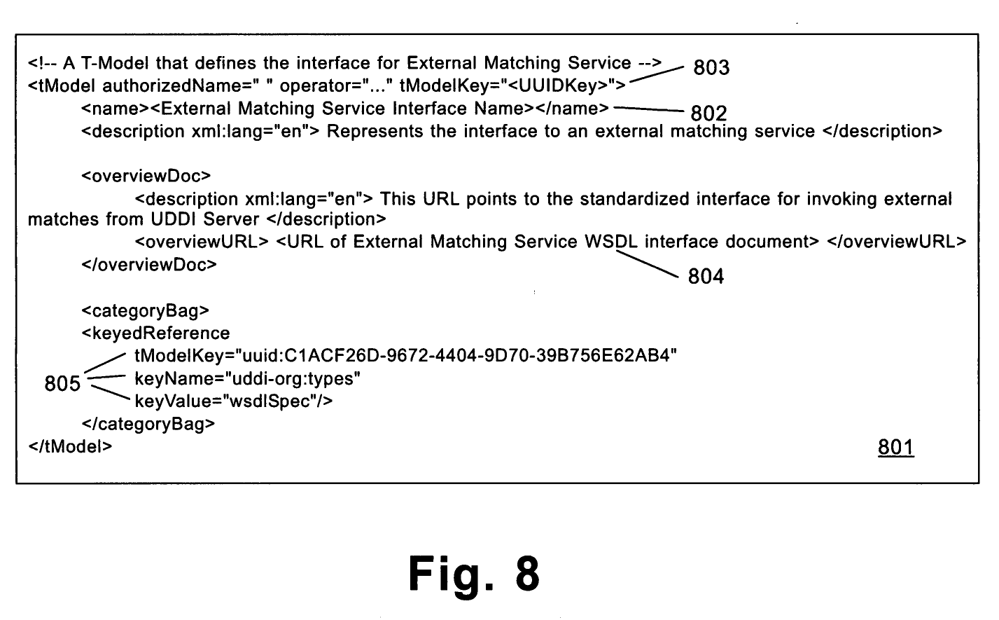

FIG. 8 is a template for a tModel which represents the interface to an external matching service, such as tModels 213, 214 and 215 of FIG. 2. These tModels are used by the UDDI registry when accessing the external matching service whose interface they represent. The tModel defines a name of the external matching service interface 802, a UUID 803, and a URL 804 which defines the location of a WSDL document which describes the interface. The figure further shows a UUID, keyName and keyValue settings 303 which define the tModel as defining a WSDL specification.

Use of the tModel templates described above will now be described by way of example. In this example a service provider, ProviderA, provides three text analysis services: “Tokenizer” which is a service that tokenizes a given document; “LexicalAnalyzer” which is a service that does lexical analysis of tokens and provides lexical analysis as output; and “NameEntityRecognizer” which is a service that can accept a given text document and return the named entities in that document. A service requester wishes to locate a text analyser which can accept a document containing, for example, the text: “Franklin D. Roosevelt entered public service through politics as a Democrat. He won election to the New York Senate in 1910. He was appointed Assistant Secretary of the Navy, and was the Democratic nominee for Vice President in 1920.”, and analyse the document to find the names of people included in the document. In this case the answer would be “Franklin D. Roosevelt” and the service which could provide such a function is the “NamedEntityRecognizer” service of ProviderA. Accordingly the purpose of the example is to show how, according to the preferred embodiment of the present invention, the client locates the “NameEntityRecognizer” service using a DAML-S semantic matching engine.

Firstly in the example, Provider A must provide details of the service which it provides to a UDDI registry. To do this ProviderA first creates DAML-S files and WSDL files which describe each service. A DAML-S file contains semantic information, using DAML-S markup language, to fully describe the service capabilities, and a WSDL file contains WSDL and SOAP binding for the services. These are created for each service and made available on a web server, for example as:

Tokenizer:
http://providerA/Tokenizer.daml
http://providerA/Tokenizer-Interface.wsdl
LexicalAnalyzer:
http://providerA/LexicalAnalyzer.daml
http://providerA/LexicalAnalyzer-Interface.wsdl
NameEntityRecognizer:
http://providerA/NameEntityRecognizer.daml
http://providerA/NamedEntityRecognizer-Interface.wsdl

Having created these files, Provider A creates two sets of tModels. The first set define the capabilities of these services using the tModel template of FIG. 5. For example for the Tokenizer service, a name such as “Tokenizer” in 502, a UUID which uniquely identifies the Tokenizer tModel in 503, and the location of the DAML-S description of the service (i.e.: http://providerA/Tokenizer.daml) at 504. These tModels also define each of the services as falling under the standard UNSPSC ‘Document Management Software’ category. The second set define the interface description for each of the services. These are standard tModels according to the UDDI specification and will contain a reference to the appropriate WSDL file which contains a definition of the interface, for example http://providerA/Tokenizer-Interface.wsdl for the Tokenizer service.

Once the above tModels have been created the provider then creates a final tModel describing business and the services which it provides. This is a standard tModel according to the UDDI specification and will include a business Service entry for each of the 3 services and each of these entries will contain references to the appropriate tModels previously created.

Having created all required tModels the provider sends these to the UDDI registry in order to make the services available to service requesters.

Secondly in the example a service requester requests details of the Named Entity Recognizer service. To do this the requester first creates a DAML-S file which describes its requirements of a Named Entity Recognizer and makes it available on a web server, for example:

http://requesterA/NamedEntityRecogniserRequirements.daml

Having created this file the requester creates a tModel to define these requirements using the template of FIG. 6. For example, a name such as “NamedEntityRecognizerRequirements” in 602, a UUID which uniquely identifies the tModel in 603, and the location of the DAML-S description of the requester requirements (i.e.: http://requesterA/NamedEntityRecognizerRequirements.daml) at 604. Note that the tModel may also specify other requirements such as those expressed using standard UDDI categories. This tModel is then provided to the UDDI registry for later use by the requester.

Now when the requester wishes to locate a NamedEntityRecognizer service based on the requirement specified in the created DAML-S file it issues a find-tModel request. This request includes a tModel which specifies the tModel which defines the service requirements, previously sent to the UDDI registry, using the “describedUsing” category.

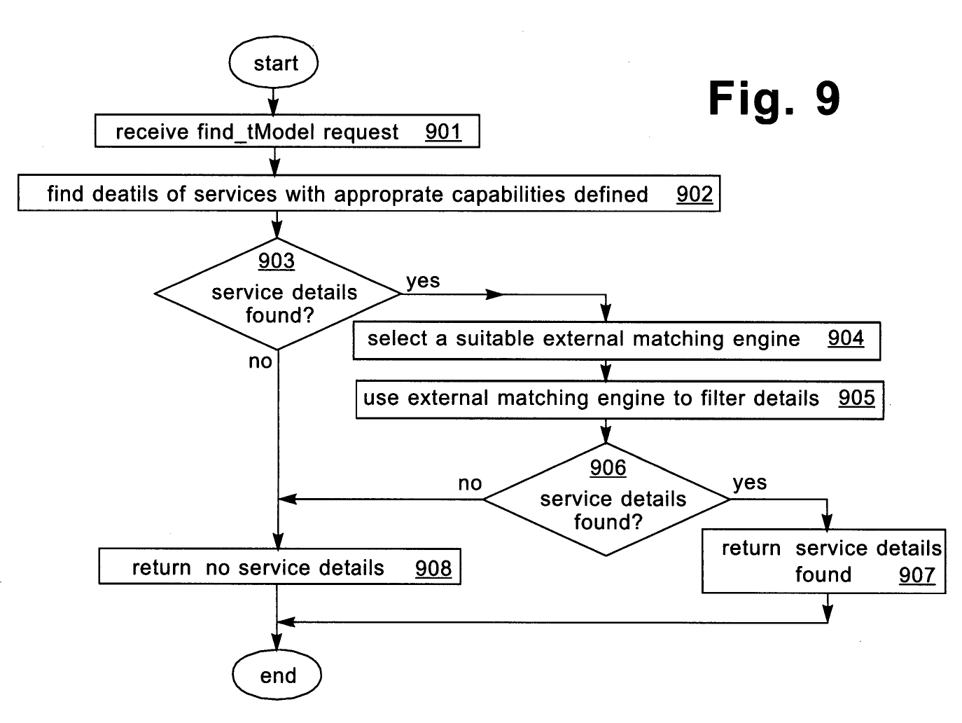

When the UDDI registry receives this request, according to the preferred embodiment of the present invention the UDDI registry follows the method as illustrated in FIG. 9. At step 901 the find_tModel request is received the request includes a tModel which contains a reference to a tModel which describes the service requirements of the requester, such a reference is specified-using the client requirements category defined in the tModel of FIG. 8. The registry obtains the referenced tModel and obtains the requirements from it. Such requirements may include, for example, requirements specified according to standard UDDI categories and further requirements specified in an external language that requires the use of an external matching engine. The UDDI registry then, at step 902, locates one or more details of services which include a definition of service capabilities that can be used to compare with the requirements specified in an external language. For example, the UDDI registry may do this by first locating details of services based on the standard UDDI categories and then reduce the details found to those which also specify service capabilities in an appropriate external language. In the case of the text analysis example, all three services namely Tokenizer, Lexical Analyzer and Named Entity Recognizer are returned at this stage since they all fall under a standard UNSPSC ‘Document Management Software’ category, and further all provide a description of their capabilities in the DAML-S language. At step 903 a check is made to see if any suitable details of services have been found and if so, at step 904 the UDDI registry selects a suitable external matching engine to use for comparing the service requirements and service capabilities. For example, if the requirements and capabilities are specified in DAML-S, a DAML-S matching engine will be chosen. However it is also possible that more than one DAML-S matching service engine has been configured with the registry, for example as provided by different matching engine providers. In this case the UDDI registry will select from those available based on a configured policy. For example, it may choose the first available the most recently provided, or rotate around those available in a round-robin fashion. Once a suitable matching engine has been selected the registry uses it at step 905 to compare the external language capabilities with requirements in order to filter down the service details to those with capabilities which match the requirements. At step 906 a check is made to see if the filtering has found one or more suitable services and, if it has, details of these are returned to the requester at step 907. In the example, this will result in the details of the NamedEntityRecognizer service of providerA being returned to the requester. Note that if step 903 or 905 does not find any suitable services then no service details are returned in response to the request at step 908.

Thus according to the present invention it is possible to plug in multiple external matching services developed by independent service providers in UDDI. For example, external-matching engines can be provided that can match descriptions written not only to DAML-S but also to other languages such as UML [UML 1997] or even WSDL. Further, there can be more than one matching engine for each supported description language. For example, there can be more than one DAML-S matching engine available to the UDDI registry for use when matching, requester service requirements with service capabilities. Further policies for the selection of matching engines can be used, for example first available, most recent, fastest etc.

The preferred embodiment of the present invention further allows for many types of matching. For example, service requesters may request not only semantic matching but also syntactic-based WSDL matching.

Accordingly, the UDDI registry of the preferred embodiment of the present invention, by hosting various matching engines, offers much needed intelligent matching of web services. This is achieved using the standard, existing UDDI inquiry mechanisms and provides better support for service requesters which need description matching.

Note that a skilled person in the art would realise that the method described with reference to FIG. 9 could be implemented in a variety of programming languages, for example, Java™, C, and C++ (Java is a registered trademark of Sun Microsystems, Inc. in the United States, other countries, or both.). Further a skilled person would realise that once implemented the methods can be stored in a computer program product comprising one or more programs, in source or executable form, on a media, such as floppy disk, CD, and DVD, suitable for loading onto a data processing host and causing the data processing host to carry out the methods. Further a skilled person would realise that the methods described with reference to FIG. 9 could be embodied in a data processing apparatus, and further used in providing a UDDI regitry service.

Thus the present invention provides a method, apparatus, computer program product and service which enables a UDDI registry to provide support for external matching services. Using tModels a service provider specifies its capabilities in a language, such as DAML-S, and a service requester specifies service requirements in the same or a similar language. As a result when a service requester contacts the registry to obtain details of service which matches the service requirements, the registry uses an external matching engine capable of comparing the capabilities and requirements in order to find suitable matching services.

1. A data processing method for a UDDI registry to enable location of details of services which match service requester requirements, the method of the UDDI registry comprising the steps:
receiving a standard UDDI request to locate service details, the request comprising details of a tModel which defines service requirements specified in a particular language;
locating details of at least one service, the details comprising a tModel which defines service capabilities specified in the particular language;
selecting from a plurality of external matching services an external matching service which is capable of comparing the service requirements and service capabilities, wherein each external matching service is accessed through an interface defined in an interface tModel; and
using the external matching service to filter the located details to find those with indicated service capabilities which match the service requirements.

2. The method of claim 1 wherein the standard UDDI request further comprises service requirements specified in a standard UDDI category, the method comprising the further step of:
finding details of at least one service, the details defining service capabilities which match the service requirements specified in a standard UDDI category;
wherein the locating step locates details of at least one service from those found by the finding step.

3. The method of claim 1 comprising the further steps of:
receiving a request to register an new external matching engine wherein the matching engine implements the interface defined in the interface tModel;
wherein the plurality of external matching services includes the new matching engine.

4. The method of claim 1 wherein the standard UDDI request is a find_tModel request.

5. The method of claim 1 wherein the particular language is one of DAML-S, UML, and WSDL.

6. A method for a service provider to provide details of capabilities of a service which it provides to a UDDI registry, the method comprising the steps:
making a description of the service capabilities accessible to the UDDI registry, the description comprising details of the service capabilities specified in a particular language, the particular language being recognisable to an external matching engine available to the UDDI registry; and
sending details of the service to the UDDI registry, the details including a tModel which includes a reference to the description and a specification of the particular language.

7. A method for a service requester to request details of services from a UDDI registry according to service requirements, the method comprising the steps:
making a description of the service requirements accessible to the UDDI registry, the description comprising details of the service requirements specified in a particular language, the particular language being recognisable to an external matching engine available to the UDDI registry;
sending a tModel to the UDDI registry, the tModel including a reference to the description and a specification of the particular language; and
sending a request to the UDDI registry to obtain details of the services according to the service requirements, the request including a reference to the tModel previously sent to the UDDI registry.

8. A UDDI registry for locating details of services which match service requester requirements, the UDDI registry comprising:
means for receiving a standard UDDI request to locate service details, the request comprising details of a tModel which defines service requirements specified in a particular language;
means for locating details of at least one service, the details comprising a tModel which defines service capabilities specified in the particular language;
means for selecting from a plurality of external matching services an external matching service which is capable of comparing the service requirements and the service capabilities, wherein each external matching service is accessed through an interface defined in an interface tModel; and
means for using the external matching service to filter the located details to find those with indicated service capabilities which match the service requirements.

9. The UDDI registry of claim 8 wherein the standard UDDI request further comprises service requirements specified in a standard UDDI category, the UDDI registry further comprising:
means for finding details of at least one service, the details defining service capabilities which match the service requirements specified in a standard UDDI category;
wherein the locating means locates details of at least one service from those found by the finding means.

10. The UDDI registry of claim 8 further comprising:
means for receiving a request to register an new external matching engine wherein the matching engine implements the interface defined in the interface tModel;
wherein the plurality of external matching services includes the new matching engine.

11. The UDDI registry of claim 8 wherein the standard UDDI request is a find_tModel request.

12. The UDDI registry of claim 8 wherein the particular language is one of DAML-S, UML, and WSDL.

13. A service provider for providing details of capabilities of a service which it provides to a UDDI registry, the service provider comprising:
means for making a description of the service capabilities accessible to the UDDI registry, the description comprising details of the service capabilities specified in a particular language, the particular language being recognisable to an external matching engine available to the UDDI registry; and
means for sending details of the service to the UDDI registry, the details including a tModel which includes a reference to the description and a specification of the particular language.

14. A service requester for requesting details of services from a UDDI registry according to service requirements, the service requester-comprising:
means for making a description of the service requirements accessible to the UDDI registry, the description comprising details of the service requirements specified in a particular language, the particular language being recognisable to an external matching engine available to the UDDI registry;
means for sending a tModel to the UDDI registry, the tModel including a reference to the description and a specification of the particular language; and
means for sending a request to the UDDI registry to obtain details of services according to the service requirements, the request including a reference to the tModel previously sent to the UDDI registry.

15. A computer program product comprising instructions which, when executed on a data processing host, cause the data processing host to carry out a method for a UDDI registry to enable location of details of services which match service requester requirements, the method comprising the steps:
receiving a standard UDDI request to locate service details, the request comprising details of a tModel which defines service requirements specified in a particular language;
locating details of at least one service, the details comprising a tModel which defines service capabilities specified in the particular language;
selecting from a plurality of external matching services an external matching service which is capable of comparing the service requirements and the service capabilities, wherein each external matching service is accessed through an interface defined in an interface tModel; and
using the external matching service to filter the located details to find those with indicated service capabilities which match the service requirements.

16. The computer program product of claim 15 further wherein the standard UDDI request further comprises service requirements specified in a standard UDDI category, the method comprising the further step of:
finding details of at least one service, the details defining service capabilities which match the service requirements specified in a standard UDDI category;
wherein the locating step locates details of at least one service from those found by the finding step.

17. The computer program product of claim 15, the method comprising the further step of:
receiving a request to register an new external matching engine wherein the matching engine implements the interface defined in the interface tModel;
wherein the plurality of external matching services includes the new matching engine.

18. The computer program product of claim 15 wherein the standard UDDI request is a find_tModel request.

19. The computer program product of claim 15 wherein the particular language is one of DAML-S, UML, and WSDL.

20. A computer program product comprising instructions which, when executed on a data processing host, cause the data processing host to carry out a method for a service provider to provide details of capabilities of a service which it provides to a UDDI registry, the method comprising the steps:
making a description of the service capabilities accessible to the UDDI registry, the description comprising details of the service capabilities specified in a particular language, the particular language being recognisable to an external matching engine available to the UDDI registry; and
sending details of the service to the UDDI registry, the details including a tModel which includes a reference to the description and a specification of the particular language.

21. A computer program product comprising instructions which, when executed on a data processing host, cause the data processing host to carry out a method for a service requester to request details of services from a UDDI registry according to service requirements, the method comprising the steps:
making a description of the service requirements accessible to the UDDI registry, the description comprising details of the service requirements specified in a particular language, the particular language being recognisable to an external matching engine available to the UDDI registry;
sending a tModel to the UDDI registry, the tModel including a reference to the description and a specification of the particular language; and
sending a request to the UDDI registry to obtain details of the services according to the service requirements, the request including a reference to the tModel previously sent to the UDDI registry.

22. A UDDI registry service for locating details of services which match service requester requirements, providing the UDDI registry service comprising the steps:
receiving a standard UDDI request to locate service details, the request comprising details of a tModel which defines service requirements specified in a particular language;
locating details of at least one service, the details comprising a tModel which defines service capabilities specified in the particular language;
selecting from a plurality of external matching services an external matching service which is capable of comparing the service requirements and service capabilities, wherein each external matching service is accessed through an interface defined in an interface tModel; and
using the external matching service to filter the located details to find those with indicated service capabilities which match the service requirements.

23. The UDDI registry service of claim 22 wherein the standard UDDI request further comprises service requirements specified in a standard UDDI category, providing the UDDI registry service comprising the further step of:
finding details of at least one service, the details defining service capabilities which match the service requirements specified in a standard UDDI category;
wherein the locating step locates details of at least one service from those found by the finding step.

24. The UDDI registry service of claim 22, providing the UDDI registry service comprising the further steps of:
receiving a request to register an new external matching engine wherein the matching engine implements the interface defined in the interface tModel;
wherein the plurality of external matching services includes the new matching engine.

25. The UDDI registry service of claim 22 wherein the standard UDDI request is a find_tModel request.

26. The UDDI registry service of claim 22 wherein the particular language is one of DAML-S, UML, and WSDL.

27. A provider service which provides details of capabilities of a service which it provides to a UDDI registry, providing the service comprising the steps:
making a description of the service capabilities accessible to the UDDI registry, the description comprising details of the service capabilities specified in a particular language, the particular language being recognisable to an external matching engine available to the UDDI registry; and
sending details of the service to the UDDI registry, the details including a tModel which includes a reference to the description and a specification of the particular language.

28. A requester service for requesting details of services from a UDDI registry according to service requirements, providing the service comprising the steps:
making a description of the service requirements accessible to the UDDI registry, the description comprising details of the service requirements specified in a particular language, the particular language being recognisable to an external matching engine available to the UDDI registry;
sending a tModel to the UDDI registry, the tModel including a reference to the description and a specification of the particular language; and
sending a request to the UDDI registry to obtain details of the services according to the service requirements, the request including a reference to the tModel previously sent to the UDDI registry.
